(19) United States
(12) Patent Application Publication
(10) Pub. No.: US 2015/0075881 A1
(43) Pub. Date: Mar. 19, 2015

(54) Single-pole Single-wheel Self-balancing Electric Vehicle

(71) Applicant: Shichuang LIU, City of He Yuan (CN)

(72) Inventor: Shichuang LIU, City of He Yuan (CN)

(21) Appl. No.: 14/093,923

(22) Filed: Dec. 2, 2013

(30) Foreign Application Priority Data
Sep. 13, 2013 (CN) 201310373775.9

(51) Int. Cl. B62K 1/00

(52) U.S. Cl. CPC B62K 1/00; B62K 2204/00; B62K 2207/00
USPC 180/21; 701/22

(57) ABSTRACT

A single-pole single-wheel self-balancing electric vehicle comprises a wheel. The wheel is provided with a tire of a small sidewall aspect ratio. The wheel is provided with a control system, a drive circuit, an electricity supply system and a power system. A sensor system is highly integrated in the centers of gravity of the support arms, which are provided on the two sides of the wheel through a stator shaft. The electricity supply system, the drive circuit, the sensor system and the power system are respectively connected with the control system. The sensor system and the power system are electrically connected with the electricity supply system respectively. Because the control system, the drive circuit, the electricity supply system and the power system are highly integrated on the wheel, the electric vehicle has a more compact structure with improved utilization of space, and improved portability. The tire of a small sidewall aspect ratio on the wheel also increases the contact area between the tire and the road, and increases the stability and self-balancing ability of the electric vehicle.

### TECHNICAL FIELD

The disclosure herein relates to an electric vehicle, in particular to a single-pole single-wheel self-balancing electric vehicle.

### BACKGROUND

The self-balancing mechanism of a self-balancing electric vehicle is based on the principle of dynamic stabilization, which is the self-balancing ability of the vehicle itself. An internal solid-state gyroscope is generally used to determine the status of the wheel. A sophisticated and high-speed central microprocessor calculates the appropriate demand, and a motor is used to realize the self-balance of the vehicle.

The currently available self-balancing electric vehicle is either a single-wheel or a two-wheel vehicle. A single-wheel self-balancing vehicle has advantages such as compactness, high portability and energy efficiency. However, its disadvantage is relatively low stability and self-balancing ability. A two-wheel vehicle has advantages such as high stability and self-balancing ability, but has disadvantages such as complexity in structure, bulkiness and low portability.

Thus, the technical difficulties to be resolved are the design of a self-balancing electric vehicle with high stability, self-balancing ability and portability.

### SUMMARY

The present disclosure provides a single-pole single-wheel self-balancing electric vehicle that has high stability, self-balancing ability and portability.

The technical schemes are as the followings.

A single-pole single-wheel self-balancing electric vehicle comprises a wheel. The wheel is provided with a tire of a small sidewall aspect ratio. The wheel is provided with a control system, a sensor system, a drive circuit, a power system and an electricity supply system. The electricity supply system, the drive circuit, the sensor system and the power system are respectively connected with the control system. The drive circuit and the power system are electrically connected with the electricity supply system respectively.

Because the control system, the electricity supply system and the power system are highly integrated on the wheel, as well as that the sensor system is highly integrated in the support arms that are tightly connected to the wheel, the electric vehicle has a more compact structure with improved utilization of space, and improved portability. The tire of a small sidewall aspect ratio as provided on the wheel also increases the contact area between the tire and the road, and increases the stability and self-balancing ability of the electric vehicle.

Preferably, the power system comprises a centrally located motor; wherein the motor is provided on the center of the wheel, and is operably connected to the wheel through a rotor shaft.

Preferably, the electricity supply system, the control system, and the drive circuit are all contained in a water-proof case, the interior of which is separated into two compartments: a battery compartment and a circuit board compartment. The electricity supply system comprises a battery, which is provided within one compartment of the case, the battery compartment. The control system and the drive circuit are provided within the other compartment of the case, the circuit board compartment. The case is connected to the motor through positioning pieces.

Preferably, the water-proof case comprises a case base, a case cover, and positioning pieces for the case base. The case cover is configured to be removably connected with the case base through screws.

Preferably, the sensor system comprises two gyroscopes to detect the overall center of gravity of the electric vehicle and a human user thereon. Each of the two gyroscopes is provided in the center of gravity of each of the two support arms, which are provided on the two ends of a stator shaft of the motor. The gyroscopes are connected with the control system.

Preferably, the control system comprises a microprocessor that is configured to receive signals of the overall center of gravity of the vehicle and a human user thereon sent by the sensor system, to analyze the changes of the signals, and to send acceleration or deceleration signals to the drive circuit, which magnifies the signals and send to the power system. The microprocessor is provided on the control system.

Preferably, the single-pole single-wheel self-balancing electric vehicle also comprises a handrest system; wherein the handrest system comprises a first aluminum rod, a second aluminum rod and a handle. A lower end of the handle is configured to be connected with an upper end of the second aluminum rod by a hinge at a hinge joint. A lower end of the second aluminum rod is configured to be removably connected with an upper end of the first aluminum rod. A lower end of the first aluminum rod is configured to be connected with an upper end of a support arm by a hinge at a hinge joint.

Preferably, the handrest system further comprises a first ratchet mechanism and a second ratchet mechanism. The first ratchet mechanism is provided at the hinge joint of the handle and the second aluminum rod for setting an angle of rotation. The second ratchet mechanism is provided at the hinge joint of the first aluminum rod and the support arm for setting an angle of rotation.

Preferably, the second aluminum rod is provided with a plurality of positioning holes. Preferably, the number of positioning holes is six. An upper end of the first aluminum rod is provided with a connecting device.

Preferably, the connecting device comprises a retaining sleeve base, a retaining sleeve with positioning holes, a spring piece and a latch. The connecting device is sleeved outside an upper end of the first aluminum rod, and is securely connected with the first aluminum rod through the spring piece. The retaining sleeve is embedded on a top of the connecting device, is positioned by the latch, and is removably connected with the second aluminum rod.

Compared to prior art, the present disclosure provides advantages in a centrally located motor, a battery, control system, drive circuit located within the wheel, for a more compact structure and a higher efficiency in utilization of space.

The present disclosure provides advantages in a big rim diameter tire with a small sidewall aspect ratio, for a reduced weight of the electric vehicle and an improved ability to cross barriers and a higher self-balancing ability. Compared to a two-wheels self-balancing vehicle, the foldable single-wheel single-pole vehicle of the present disclosure is superior in fashion, stability and safety. During its use, because the torque generated by the two hands of a user of the vehicle is very small, the single-pole single-wheel self-balancing electric vehicle is unlikely to be unbalanced due to the uneven forces. The user-friendly design in the structure of the handle and pole provides enhanced safety and appeal to a user. The handrest system may be folded when not in use to save space. The handrest system is upright in front of the electric vehicle during it use, and is adjustable in height for support to the hands of a user. The overall weight of the present single-pole single-wheel self-balancing electric vehicle is below 25 kilogram for an enhanced portability. The design of a single-wheel greatly reduces friction in travel and is more energy efficient. The overall system of the single-pole single-wheel self-balancing electric vehicle is simple in structure, and has significantly reduced the cost of production for better product marketability in the future.

### BRIEF DESCRIPTION OF FIGURES

FIG. 1 is an embodiment of a three-dimensional structural view of a single-pole single-wheel self-balancing electric vehicle.

FIG. 2 is a view of a water-proof case, with an electricity supply system, a control system and a drive circuit provided inside the water-proof case.

FIG. 3 is a view of a water-proof case connecting to the motor through positioning pieces.

FIG. 4 is an explosion view of the rotor shaft connecting to the wheel of the electric vehicle, as well as an explosion view of the stator shaft

FIG. 5 is an explosion view of the support arms connecting to the stator shaft, as well as an explosion view of the gyroscopes.

FIG. 6 is an explosion view of the handrest system.

### DETAILED DESCRIPTION

The embodiments of the present disclosure are further illustrated below in view of the accompanying drawings. The embodiments described herein are only some of the possible embodiments of the present invention. Other embodiments based on the present disclosure derived by one skilled in the art without an inventive step also belong to the protection scope of the present disclosure.

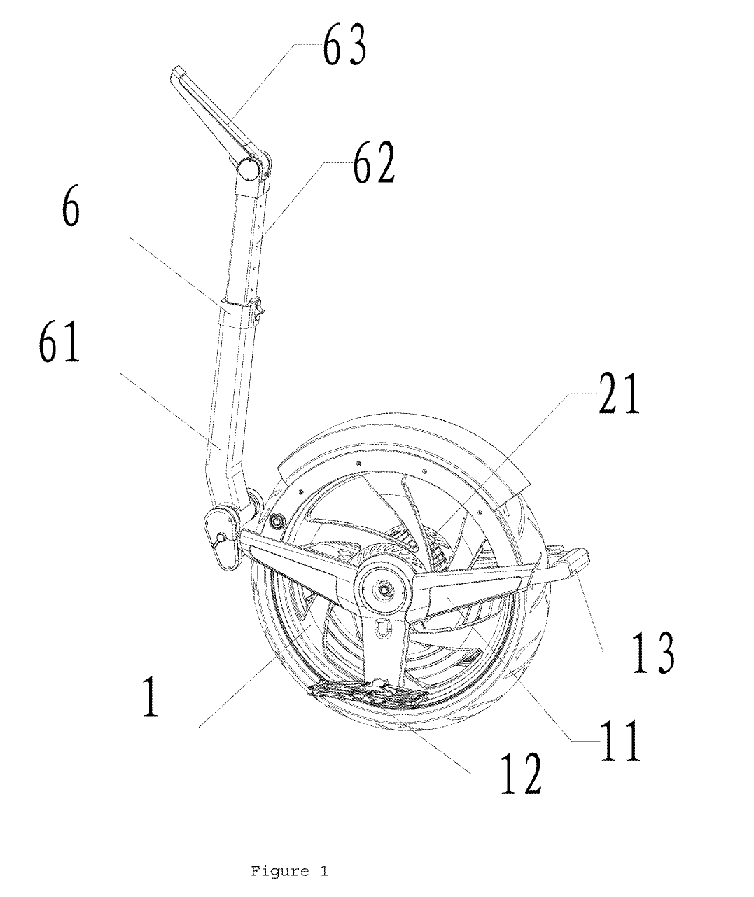

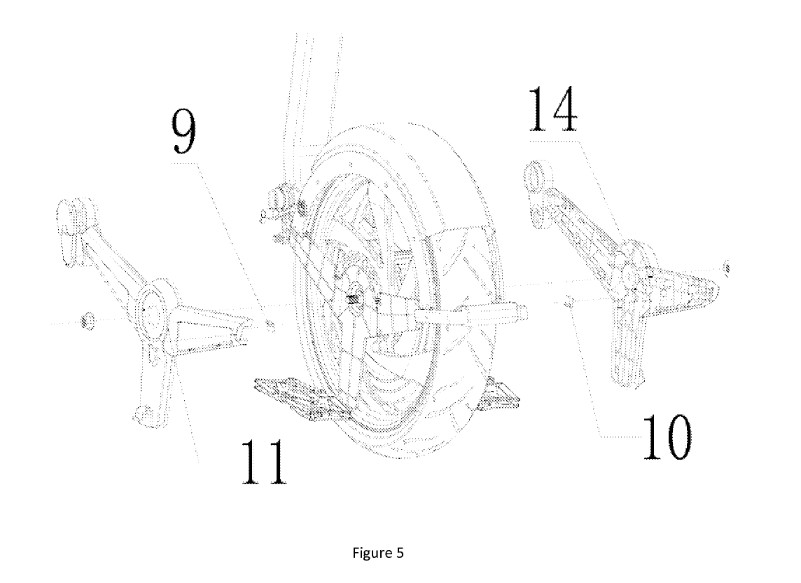

As shown in FIG. 1 to FIG. 6, a single-pole single-wheel self-balancing electric vehicle comprises a wheel 1. The wheel 1 is provided with a tire 15 of a small sidewall aspect ratio. The wheel 1 is provided with a control system 4, an electricity supply system 3, a drive circuit 2, a sensor system comprising two gyroscopes 9 and 10, and a power system 21. The electricity supply system 3, the sensor system and the power system 21 are respectively connected with the control system 4. The sensor system and the power system 21 are electrically connected with the electricity supply system 3 respectively.

Because the control system 4, the electricity supply system 3, the drive circuit 2, and the power system 21 are highly integrated on the wheel 1, while the sensor system, comprising two gyroscopes 9 and 10, is highly integrated inside the support arms, the electric vehicle has a more compact structure with improved utilization of space, and improved portability. The tire 15 on the wheel 1 also increases the contact area between the tire and the road, and increases the stability and self-balancing ability of the electric vehicle.

In an embodiment, the power system 21 comprises a centrally located motor 23; wherein the motor 23 is provided on the center of the wheel 1, and is operably connected to the wheel 1 through a rotor shaft 24, so as to output power to the wheel 1.

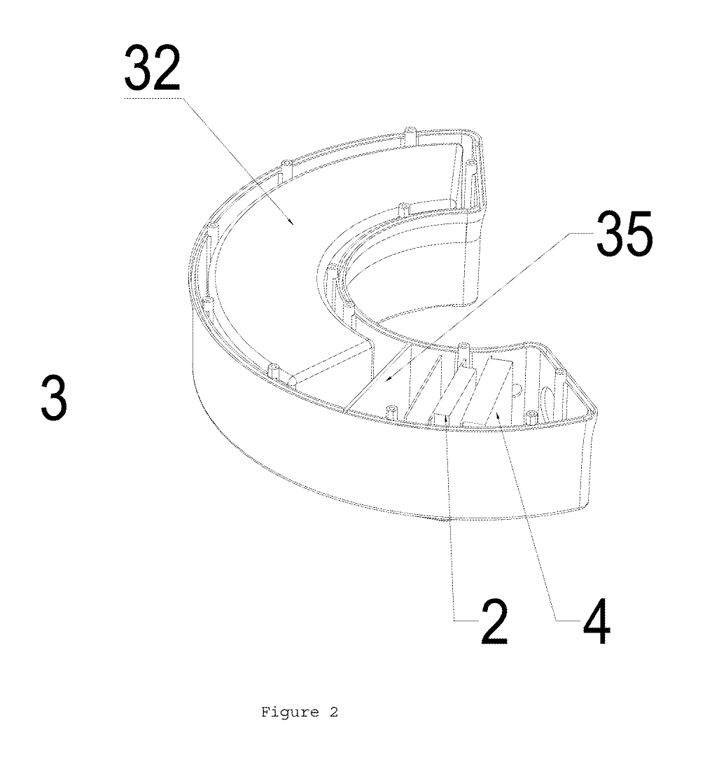

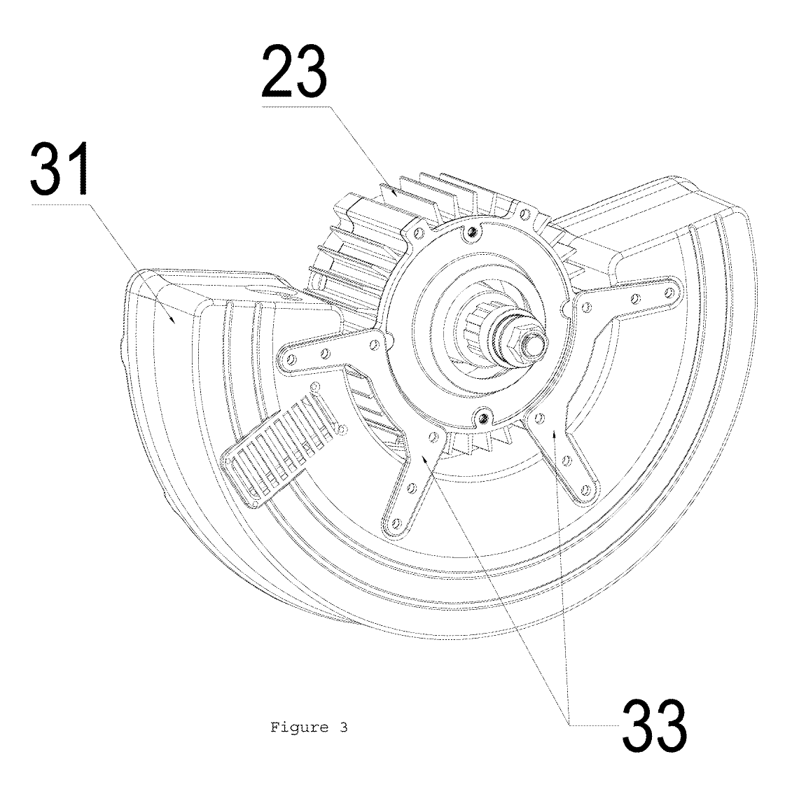

As shown in FIGS. 2 and 3, a water-proof case is separated into two compartments by a piece of plastic 35. The case comprises a case base 31 and case cover. The electricity supply system 3 comprises a battery 32, which is provided within one compartment of the case. The control system and the drive circuit are provided within the other compartment of the case. As shown in FIG. 3, the case base is configured to be removably connected with the motor 23 through the positioning pieces 33, so as to provide electricity to motor 23. The case cover is configured to be removably connected with the case base 31.

According to an embodiment, the sensor system comprises two gyroscopes 9 and 10. Gyroscope 9 is to detect the overall center of gravity of the electric vehicle and a human user thereon, while gyroscope 10 is a redundancy, which starts working once gyroscope 9 is at fault. The gyroscopes 9 and 10 are provided in centers of gravity of the support arms 11 and 14, respectively, and are connected with the control system 4.

The control system 4 comprises a microprocessor that is configured to receive the signals of the overall center of gravity of the vehicle and a human user thereon sent by the sensor system, to analyze the changes of the signals, and to send acceleration or deceleration signals to the drive circuit 2, which magnifies the signals and sends to the power system 21. The microprocessor is provided on the control system 4.

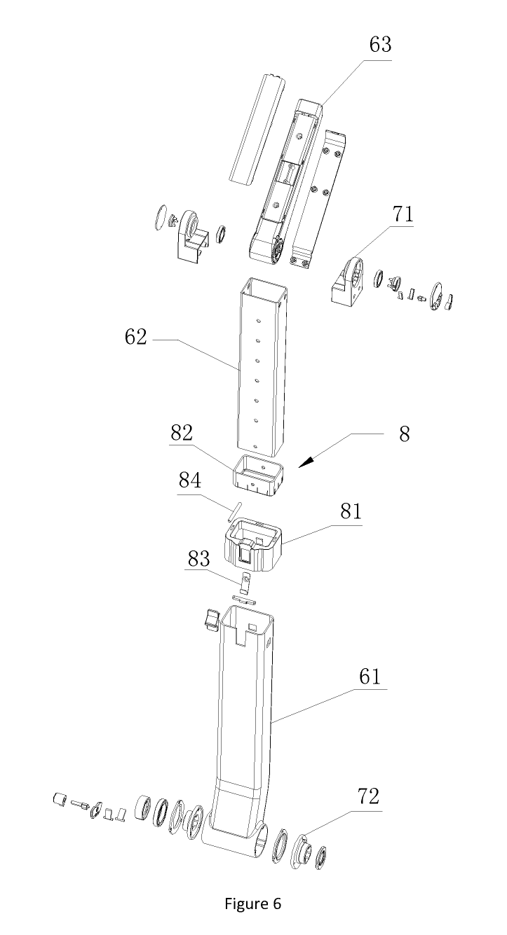

As shown in FIG. 6, according to an embodiment, the single-pole single-wheel self-balancing electric vehicle also comprises a handrest system 6; wherein the handrest system 6 comprises a first aluminum rod 61, a second aluminum rod 62 and a handle 63. A lower end of the handle 63 is configured to be connected with an upper end of the second aluminum rod 62 through a hinge. A lower end of the second aluminum rod 62 is configured to be removably connected with an upper end of the first aluminum rod 61. A lower end of the first aluminum rod 61 is configured to be connected with an upper end of a support arm 11 by a hinge. As such, the single-pole single-wheel self-balancing electric vehicle may be folded at two joints.

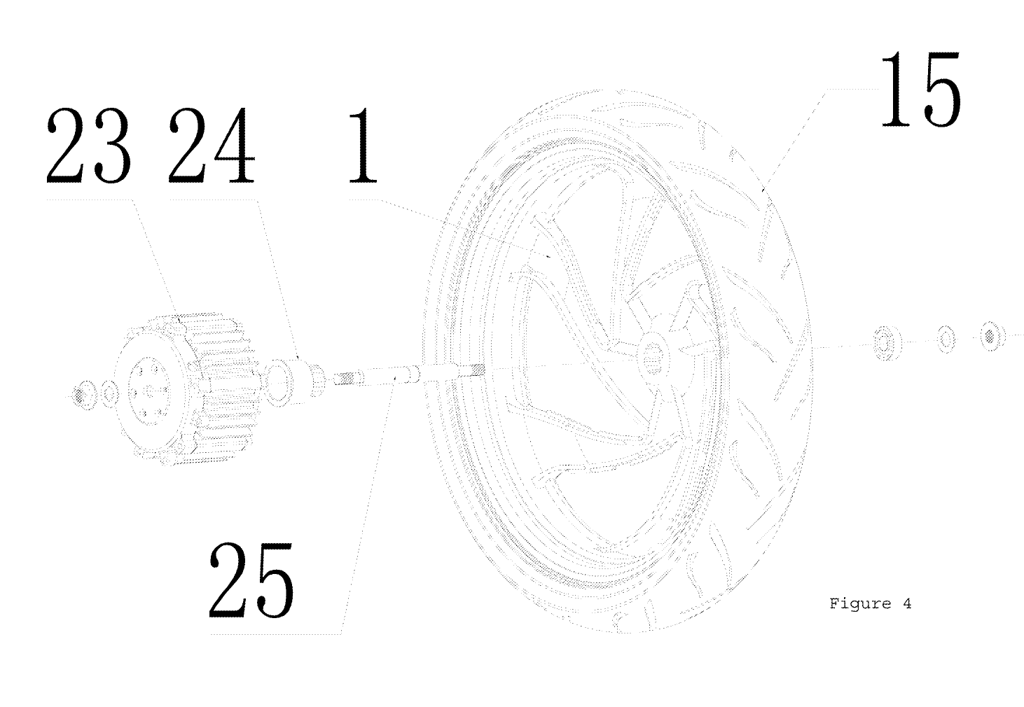

A first ratchet mechanism 71 is provided at the hinge joint of the handle 63 and the second aluminum rod 62 for setting an angle of rotation. A second ratchet mechanism 72 is provided at the hinge joint of the first aluminum rod and the support arm 11 for setting an angle of rotation. The support arms 11 and 14 are connected to two ends of the stator shaft 25 shown in FIG. 4. The support arm 11 and 14 are further tightened together by a lifting bar 13 through screws.

In the present embodiment, six positioning holes are provided on the second aluminum rod 62. A connecting device 8 is provided at an upper end of the first aluminum rod 61. The connecting device 8 is configured to match the positioning holes. The connecting device 8 comprises a retaining sleeve base 81, a retaining sleeve 82 with positioning holes, a spring piece 83 and a latch 84. The connecting device 8 is sleeved outside an upper end of the first aluminum rod 61, and is securely connected with the first aluminum rod 61 through the spring piece 83. The retaining sleeve 82 is embedded on a top of the connecting device 8, is positioned by the latch 84, and is removably connected with the second aluminum rod 62.

Prior to use, rotating the handle 63 to a outmost end around the rotor shaft; securing the handle 63 and the second aluminum rod 62 through turning a knob on the first ratchet mechanism 71; rotating the first aluminum rod 61 to a outmost position around the support arm 11; securing the first aluminum rod 61 and the wheel 1 through the second ratchet mechanism 72. The height of the handle 6 is adjustable at six levels, by the relative position of the first aluminum rod 61 and the second aluminum rod 62, and the combined action of the retaining sleeve 82, the latch 84 and the positioning holes on the second aluminum rod 62. The foot pedal 12 is placed at a level position and the electric vehicle starts by the press of an on button.

The descriptions above are intended to be illustrative, not limiting. Thus, it will be apparent to one skilled in the art that modifications may be made without departing from the scope of the claims set out below.

What is claimed is:

1. A single-pole single-wheel self-balancing electric vehicle, comprising a wheel; wherein the wheel is provided with a tire of a small sidewall aspect ratio; wherein the wheel is provided with a control system, a drive circuit, an electricity supply system, a sensor system and a power system; wherein the electricity supply system, the sensor system, the drive circuit and the power system are respectively connected with the control system; wherein the sensor system and the power system are electrically connected with the electricity supply system respectively.

2. The single-pole single-wheel self-balancing electric vehicle of claim 1, wherein the power system comprises a centrally located motor; wherein the motor is provided on a center of the wheel, and is operably connected to the wheel through a rotor shaft.

3. The single-pole single-wheel self-balancing electric vehicle of claim 1, wherein the electricity supply system comprises a water-proof case, which is separated into two compartments by a piece of plastic, and a battery provided within one of the two compartments of the water-proof case; wherein the water-proof case is provided on the motor.

4. The single-pole single-wheel self-balancing electric vehicle of claim 3, wherein the water-proof case comprises a case base, a battery cover, and positioning pieces for the case base; wherein the case base is configured to be removably connected with the motor through the positioning pieces, while the case cover is configured to be removably connected with the case base through screws.

5. The single-pole single-wheel self-balancing electric vehicle of claim 1, wherein the sensor system comprises two gyroscopes: a primary gyroscope and a redundant gyroscope; wherein the primary gyroscope is configured to detect the overall center of gravity of the electric vehicle and a human user thereon, while the redundant gyroscope is configured to start working whenever the primary gyroscope is at fault; wherein the two gyroscopes are highly integrated in the centers of gravity of the support arms, which are provided on the two sides of the wheel through a stator shaft; wherein the two gyroscopes are connected with the control system.

6. The single-pole single-wheel self-balancing electric vehicle of claim 1, wherein the control system comprises a microprocessor that is configured to receive signals of an overall center of gravity of the vehicle and a human user thereon sent by the sensor system, to analyze the changes of the signals, and to send acceleration or deceleration signals to the drive circuit, which magnifies the signals and sends to the power system; wherein the microprocessor is provided on the control system.

7. The single-pole single-wheel self-balancing electric vehicle of claim 1, further comprising a handrest system; wherein the handrest system comprises a first rod, a second rod and a handle; wherein a lower end of the handle is configured to be connected with an upper end of the second rod by a hinge at a hinge joint; wherein a lower end of the second rod is configured to be removably connected with an upper end of the first rod; wherein a lower end of the first rod is configured to be connected with an upper end of a support arm by a hinge at a hinge joint.

8. The single-pole single-wheel self-balancing electric vehicle of claim 7, wherein the handrest system further comprises a first ratchet mechanism and a second ratchet mechanism; wherein the first ratchet mechanism is provided at the hinge joint of the handle and the second rod for setting an angle of rotation; wherein the second ratchet mechanism is provided at the hinge joint of the first rod and the support arm for setting an angle of rotation.

9. The single-pole single-wheel self-balancing electric vehicle of claim 7, wherein an upper end of the first rod is provided with a connecting device.

10. The single-pole single-wheel self-balancing electric vehicle of claim 9, wherein the connecting device comprises a retaining sleeve base, a retaining sleeve with positioning holes, a spring piece and a latch; wherein the connecting device is sleeved outside an upper end of the first rod, and is securely connected with the first rod through the spring piece; wherein the retaining sleeve is embedded on a top of the connecting device, is positioned by the latch, and is removably connected with the second rod.

11. The single-pole single-wheel self-balancing electric vehicle of claim 7, wherein the second rod is provided with a plurality of positioning holes.

12. The single-pole single-wheel self-balancing electric vehicle of claim 7, wherein the first rod or the second rod is made of aluminum or an aluminum alloy.

13. The single-pole single-wheel self-balancing electric vehicle of claim 1, further comprising a handrest system that is operably connected with the wheel; wherein the handrest system is configured to be foldable at a first hinge joint and a second hinge joint; wherein the height of the handrest system is adjustable; wherein the handrest system is configured to be in an upright position to provide a support to a user of the electric vehicle.
